(19) United States
(12) Patent Application Publication
(10) Pub. No.: US 2010/0209616 A1
(43) Pub. Date: Aug. 19, 2010

(54) ELECTROSTATIC COATING METHOD AND ELECTROSTATIC COATING APPARATUS

(75) Inventors: Mitsuya MURATA, Tochigi (JP); Naoki Kishimoto, Tochigi (JP); Kenta Toda, Tochigi (JP)

Correspondence Address: ARENT FOX LLP, 1050 CONNECTICUT AVENUE, N.W., SUITE 400, WASHINGTON, DC, 20036, US

(73) Assignee: HONDA MOTOR CO., LTD, Tokyo (JP)

(21) Appl. No.: 12/700,601

(22) Filed: Feb. 4, 2010

(30) Foreign Application Priority Data
Feb. 16, 2009 (JP) P2009-033086
Feb. 16, 2009 (JP) P2009-033121
Feb. 16, 2009 (JP) P2009-033130
Feb. 16, 2009 (JP) P2009-033138

(51) Int. Cl. B05D 1/04; B05B 5/025

(52) U.S. Cl. 427/475; 118/688

(57) ABSTRACT

An electrostatic coating method is provided. The electrostatic coating method includes: providing a rotary atomization type coating apparatus; supplying a coating material to a rotary atomization head of the rotary atomization type coating apparatus; changing the number of rotations of the rotary atomization head to change a particle diameter of particles of the coating material; adding a solvent to the coating material so that a NV value of a coated film formed on a coated surface of a workpiece falls within a predetermined range; and electrostatically coating the coated surface with the coating material.

This application claims priorities from Japanese Patent Application No. 2009-033086, filed on Feb. 16, 2009, Japanese Patent Application No. 2009-033121, filed on Feb. 16, 2009, Japanese Patent Application No. 2009-033130, filed on Feb. 16, 2009, and Japanese Patent Application No. 2009-033138, filed on Feb. 16, 2009, the entire contents of which are hereby incorporated by reference.

### FIELD OF THE INVENTION

The present invention relates to an electrostatic coating method and an electrostatic coating apparatus. Specifically, the present invention relates to an electrostatic coating method of electrostatically coating a coated surface of a vehicle, and an electrostatic coating apparatus thereof.

### DESCRIPTION OF RELATED ART

The related art discloses a three-coating three-baking method as a technique of coating a vehicle body. The three-coating three-baking method is a processing method including electrodeposition coating, baking, middle coating, baking, base coating, clear coating, and baking in that order. In the above coating processes, for example, a rotary atomization type coating apparatus is used as a coating apparatus. The rotary atomization type coating apparatus rotates a rotary atomization head while applying a high voltage to the rotary atomization head, and supplies a liquid coating material to the rotary atomization head in this state. The liquid coating material is charged and atomized, and the liquid coating material is sprayed from a tip edge of the rotary atomization head, thereby performing electrostatic coating.

In a luxury car, high smoothness is required for the appearance of the vehicle. Therefore, when the body of the luxury car is coated, it is usual that a wet-polishing process is carried out after a middle coating process. The wet-polishing process is a process of polishing a vehicle body manually by a sanding machine, etc. while pouring water on the vehicle body. For example, JP-A-58-124571 and JP-A-4-145979 disclose the wet-polishing process.

However, if the wet-polishing process is carried out, substantial time is required for a worker to learning the process. Additionally, the cost required to employ a worker increases, and the manufacturing cost of vehicles becomes high.

Thus, in the base coating process using a metallic pigmented coating material, a technique of enhancing the deposition efficiency of a coated film is suggested. JP-A-6-114327 discloses a technique of elevating the number of rotations of a rotary atomization head of a rotary atomization type coating apparatus, thereby further atomizing particles of the coating material, and spraying the particles to a coated surface, and thereby, metallic brightness is enhanced. In a case where such a technique is applied to middle coating or clear coating, irregularities caused by lamination of the particles of the coating material are minimized when the particles of the coating material are deposited on a coated surface by atomizing the particles of the coating material. Thus, the improvement in the smoothness of the surface of the vehicle body is expected.

JP-A-6-269704 discloses another technique for maintaining the smoothness of a coated surface constantly. In JP-A-6-269704, by detecting the smoothness of the coated surface and comparing the detected smoothness with a reference value, coating conditions, such as the discharge amount of a coating material, are corrected according to a change in the detection value of smoothness, and the smoothness of the coated surface is kept constant. When the particles of the coating material are deposited on the coated surface by changing the discharge amount of the coating material, for example, reducing the discharge amount to atomize the particles of the coating material, irregularities caused by lamination of particles of the coating material are minimized. Thus, the improvement of the smoothness of the coated surface is expected.

However, in the related art, the specific surface area (the ratio of surface area to volume) of the particles of the coating material increases by atomizing the particles of the coating material. Therefore, the degree of volatilization of a solvent in the particles of the coating material increases. Consequently, there is a case where the particles of the coating material are dried before being sufficiently adapted to the coated surface, and irregularities may remain in the coated surface.

JP-A-6-277574 discloses another technique of maintaining the finish of a coated surface. Specifically, JP-A-6-277574 discloses a technique of adding various solvents to a coating material according to the temperature of the coating material, the viscosity of the coating material, and booth temperature, thereby holding the finish of the coated surface uniformly. More Specifically, a solvent is stored in a thinner tank and, and the solvent is pumped to a coating material tank by a pump.

However, the coating material tank with large capacity as in JP-A-6-277574 is sufficiently adapted to a supply precision of a general-purpose pump as a means which supplies the solvent. However, the coating material tank is set in a place apart from the coating booth via circulation piping. Thus, in a large amount of coating material adjusted by a thinner, it is not possible to follow a change in the environment of the coating booth instantaneously. Thus, for example, a technique of performing thinner adjustment of the coating material in the vicinity of a coating gun can be considered. In this case, the amount of the coating material supplied to each coating gun is small, and the amount of the thinner mixed with the coating material also becomes extremely small. Consequently, in the above general-purpose pump, it becomes difficult to control the supply of an extremely small amount of thinner. If the amount of the thinner is too large, sagging occurs, which become a coating defect. On the other hand, if the amount of the thinner is too small, there is a case where fluidity may be lost before the particles of the coating material are adapted to the coated surface, and irregularities may remain in the coated surface.

Particularly, when the side faces of a vehicle body are coated, the problem of the smoothness of the coated surface becomes marked. In a case where the top face of a vehicle body, such as a bonnet or a roof, is coated, gravity acts on a coated surface vertically even if particles of a coating material are deposited on the coated surface, and irregularities are generated. Therefore, the particles of the coating material are easily adapted to the shape of the coated surface due to surface tension and gravity. However, in a case where the side faces of a vehicle body, such as a fender or a door panel, gravity acts along a coated surface when the particles of a coating material are deposited on the coated surface, and irregularities are generated. Thus, the particles of the coating material are hardly adapted to the shape of the coated surface due to gravity.

### SUMMARY OF INVENTION

Illustrative aspects of the present invention provide an electrostatic coating method capable of further improving the smoothness of a coated surface, and an electrostatic coating apparatus thereof.

According to a first aspect of the invention, an electrostatic coating method of electrostatically coating a coated surface (for example, the body 20 which will be described later) by using a rotary atomization type coating apparatus (for example, the coating gun 30 which will be described later). The number of revolutions of a rotary atomization head (for example, the rotary atomization head 32 which will be described later) of the rotary atomization type coating apparatus is changed to change the particle diameter of particles of the coating material while a coating material is supplied to the rotary atomization head, and a solvent is added to the coating material so that the NV value of a coated film falls within a predetermined range.

Here, the NV (Nonvolatile: the amount of non-volatilization of a coating material) value is expressed by, for example, the following expression.

NV=(Mass of Coating Material after Drying)/(Mass of Coating Material before Drying)×100

Additionally, as a solvent to be added, a high melting-point solvent is more preferable because the amount of solvent may be small.

According to a second aspect of the invention, an electrostatic coating method of electrostatically coating a coated surface (for example, the body 20 which will be described later) by using a rotary atomization type coating apparatus (for example, the coating gun 30 which will be described later). The supply amount of a coating material to a rotary atomization head (for example, the rotary atomization head 32 which will be described later) of the rotary atomization type coating apparatus is changed to change the particle diameter of particles of the coating material while the rotary atomization head is rotated, and a solvent is added to the coating material so that the NV value of a coated film falls within a predetermined range.

According to a third aspect of the invention, an electrostatic coating apparatus (for example, the clear coating facility 10 which will be described later) includes a coating material supply unit (for example, the coating material supply pipe 41 and gear pump 43 which will be described later) which supplies a coating material, a solvent supply unit (for example, the solvent supply pipe 42 and solvent discharger 44 which will be described later) which supplies a solvent, a mixing unit (for example, the static mixer 45 which will be described later) which mixes the coating material supplied from the coating material supply unit and the solvent supplied from the solvent supply unit, a rotary atomization type coating apparatus (for example, the coating gun 30 which will be described later) which sprays the coating material and solvent mixed by the mixing unit, and a control unit (for example, the control device 50 which will be described later) which controls these unit. The control unit drives the solvent discharge unit to adjust the supply amount of the solvent so that the NV value of a coated film formed on a coated surface (for example, the body 20 which will be described later) falls within a predetermined range.

According to a fourth aspect of the invention, an electrostatic coating method of carrying out electrostatic coating by using a coating material supply unit which supplies a coating material, a solvent supply unit which supplies a solvent, a mixing unit which mixes the coating material supplied from the coating material supply unit and the solvent supplied from the solvent supply unit, and a rotary atomization type coating apparatus which sprays the coating material and solvent mixed by the mixing unit. The solvent discharge unit is driven to adjust the supply amount of the solvent so that the NV value of a coated film formed on a coated surface falls within a predetermined range.

Other aspects and advantages of the invention will be apparent from the following description, the drawings and the claims.

### BRIEF DESCRIPTION OF THE DRAWINGS

FIG. 1 is a partial plan view of a coating line to which an electrostatic coating method according to first to fourth embodiments of the invention is applied.

FIG. 2 is a perspective view of a clear coating facility which constitutes the coating line.

FIG. 3 is a schematic diagram showing paths of a coating material and a solvent of the clear coating facility.

FIG. 4 is a first schematic diagram for explaining the operation of the clear coating facility.

FIG. 5 is a second schematic diagram for explaining the operation of the clear coating facility.

FIG. 6 is a third schematic diagram for explaining the operation of the clear coating facility.

FIG. 7 is a fourth schematic diagram for explaining the operation of the clear coating facility.

FIG. 8 is a fifth schematic diagram for explaining the operation of the clear coating facility.

FIG. 9 is a sixth schematic diagram for explaining the operation of the clear coating facility.

FIG. 10 is a view showing the relationship between the number of revolutions of a rotary atomization head and the NV value in the first embodiment.

FIG. 11 is a view showing the relationship between the number of revolutions of the rotary atomization head and LW value in the first embodiment.

FIG. 12 is a view showing the relationship between the discharge amount of the rotary atomization head and the NV value in the second embodiment.

FIG. 13 is a view showing the relationship between the discharge amount of the rotary atomization head and the LW value in the second embodiment.

FIG. 14 is a view showing the relationship between the number of revolutions of the rotary atomization head and the NV value in the third embodiment.

FIG. 15 is a view showing the relationship between the number of revolutions of the rotary atomization head and the LW value in the third embodiment.

FIG. 16 is a schematic diagram showing paths of a coating material and a solvent of the clear coating facility according to the fourth embodiment.

FIG. 17 is a view showing the relationship between command value and actual measurement value of the discharge amount about a gear pump and a solvent discharger in the fourth embodiment.

### DETAILED DESCRIPTION OF EXEMPLARY EMBODIMENTS

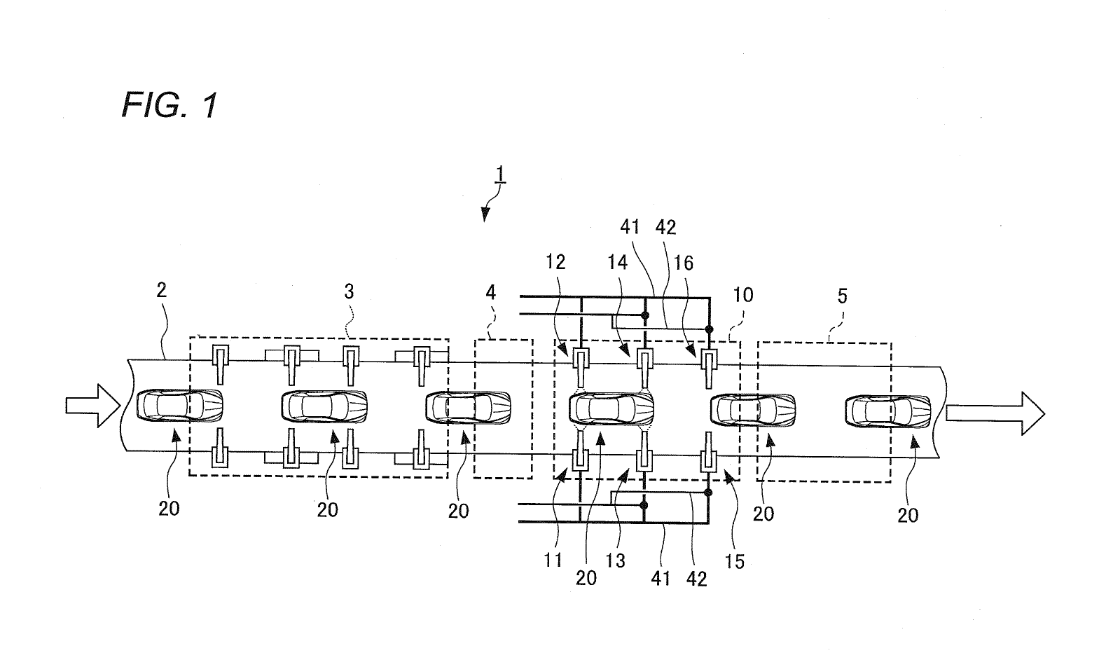

Hereinafter, a first embodiment of the invention will be described on the basis of FIGS. 1 to 11. FIG. 1 is a plan view of an outline of a portion of a coating line 1 to which an electrostatic coating method according to the first embodiment of the invention is applied. The coating line 1 performs finish coating (base coating and clear coating). A portion of the coating line 1 is shown in FIG. 1. In the coating line 1, a base coating facility 3, a flash-off facility 4, a clear coating facility 10, and a baking facility 5 are provided in that order along a carrying path 2 on which a body 20 of an automobile is carried.

The base coating facility 3 is a facility which performs base coating on middle coating in the body 20 as a coated surface, and the flash-off facility 4 is a facility which performs flash-off after the base coating. The clear coating facility 10 is a facility which performs clear coating on the body 20 after the flash-off is performed, and the baking facility 5 is a facility which bakes finish coating (base coating and clear coating).

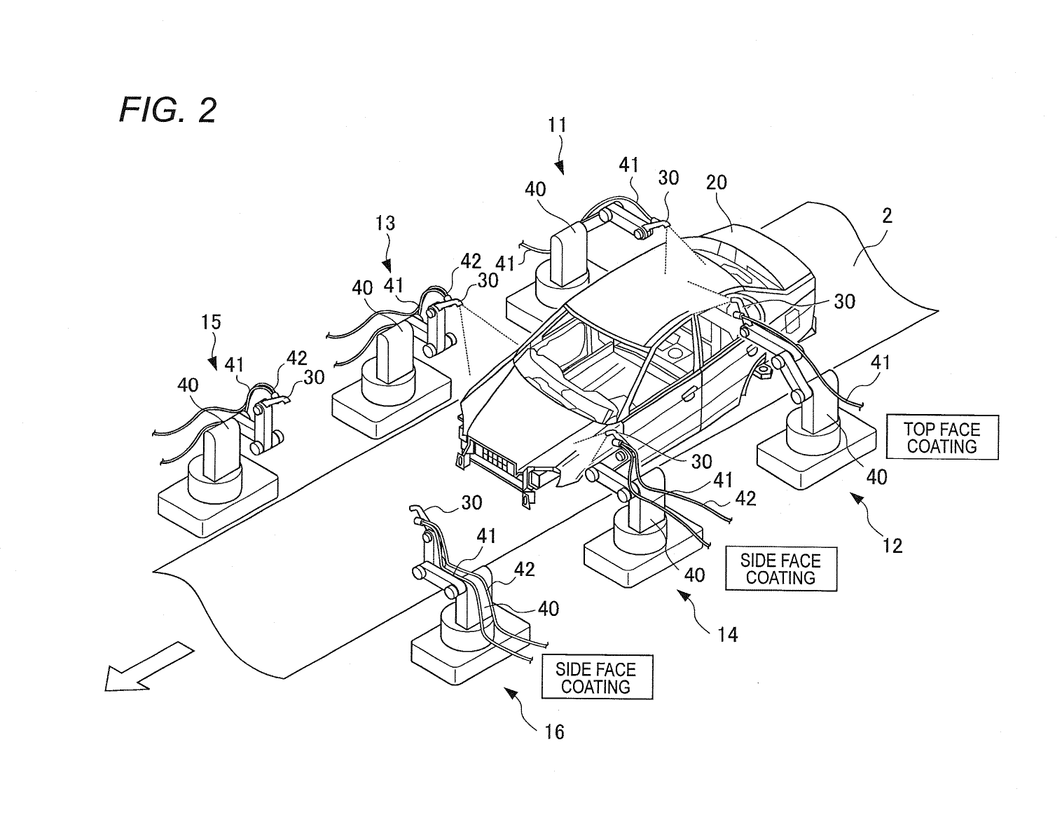

FIG. 2 is a perspective view of the clear coating facility 10. The clear coating facility 10 includes six coating robots 11 to 16 provided on both sides of the carrying path 2, coating material supply pipes 41 serving as coating material supply unit which supply a coating material to the coating robots 11 to 16, respectively, and solvent supply pipes 42 serving as solvent supply unit which supply a solvent to the coating material supply pipes which are connected to the coating robots 13 to 16 among the coating material supply pipes 41 (refer to FIG. 1). The coating robots 11 and 12 are top face coating robots which are arranged across the carrying path 2 on the most upstream side to coat the top face of the body 20. The coating robots 13 and 14 are side face coating robots which are arranged across the carrying path 2 on the downstream side of the coating robots 11 and 12 to coat the side faces of the body 20. The coating robots 15 and 16 are side face coating robots which are arranged across the carrying path 2 on the downstream side of the coating robots 13 and 14 to coat the side faces of the body 20.

Each of the coating robots 11 to 16 has a coating gun 30 as a rotary atomization type coating apparatus which sprays a coating material, and a robot arm 40 which adjusts the position of the coating gun 30 on a three-dimensional space.

Next, a method of mixing a coating material and a solvent will be described. As the method of mixing a coating material and a solvent, there are three kinds of methods including premixing, static mixer mixing, and gun head internal mixing. The premixing is a method of providing an agitator closer to a coating material tank than a coating robot, and mixing a coating material and a solvent by this agitator. In this premixing, a flow passage from the agitator to the coating gun is cleaned when a color change is performed. The static mixer mixing is a method of providing a static mixer in the vicinity of a robot body and mixing a coating material and a solvent by this static mixer. In this static mixer mixing, the path from the static mixer to the coating gun only has to be cleaned when a color change is performed. Consequently, compared with the premixing, the path to be cleaned becomes shorter, the time required for the change of a coating color can be shortened, and a coating material loss can also be reduced.

The gun head internal mixing is a method of mixing a coating material and a solvent inside a coating gun. In the gun head internal mixing, the inside of the coating gun only has to be cleaned when a color change is performed. Thus, compared with the static mixer premixing, the path to be cleaned becomes still shorter, the time required for the change of a coating color can be further shortened, and a coating material loss can also be further reduced. In the first embodiment, of the above three kinds of mixing method the gun head internal mixing is adopted.

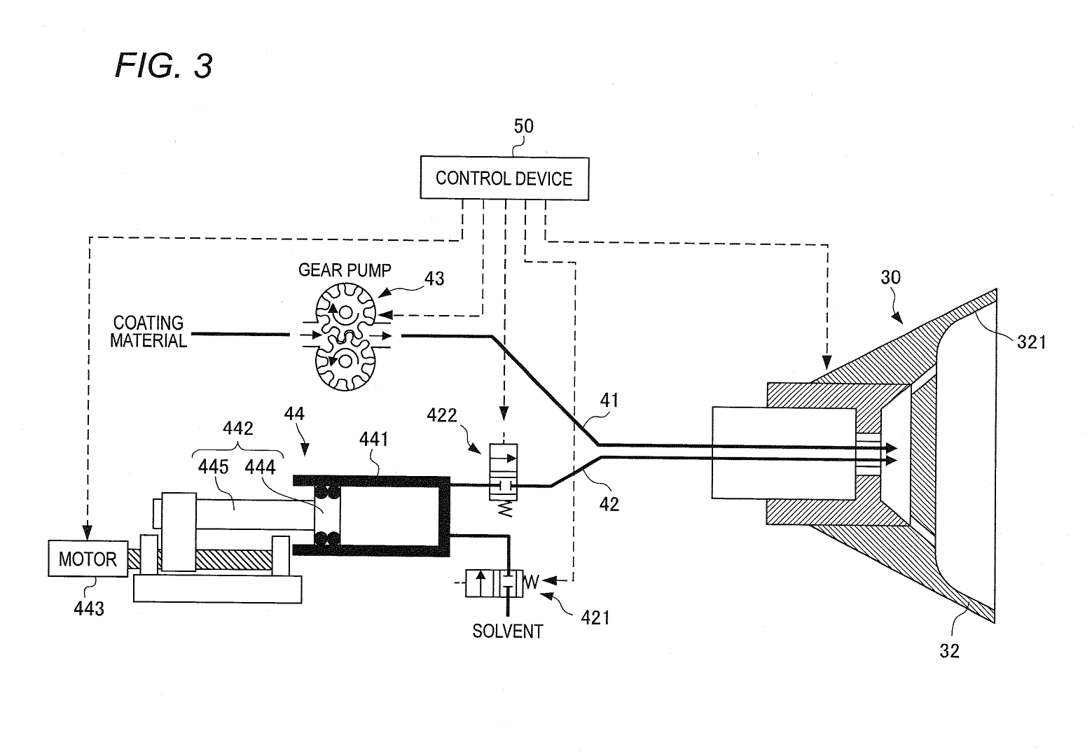

FIG. 3 is a schematic diagram showing paths of a coating material and a solvent of the clear coating facility 10. The gun head internal mixing is adopted in the clear coating facility 10 as described above. That is, the coating material supply pipe 41 and the solvent supply pipe 42 are connected to the coating gun 30 of each of the coating robots 13 to 16. A gear pump 43 is provided in the middle of the coating material supply pipe 41.

A solvent discharger 44 is provided in the middle of the solvent supply pipe 42, and valves 421 and 422 are provided on the upstream and downstream sides of solvent discharger 44 of the solvent supply pipe 42. The coating gun 30 mixes and sprays the coating material supplied through the coating material supply pipe 41 and the solvent supplied through the solvent supply pipe 42.

The coating gun 30 includes a main body which is not shown, and a rotary atomization head 32 rotatably provided in the main body.

The main body is cylindrical, and includes an air motor (not shown) which rotates the rotary atomization head 32 with the air pumped from a compressor, and a high-voltage generator (not shown) which charges the coating material, other than the coating material supply pipe 41 which supplies the coating material to the rotary atomization head 32, and the solvent supply pipe 42 which supplies the solvent to the rotary atomization head 32. The rotary atomization head 32 is formed with an expanding face 321 which expands toward a spraying direction. The coating material supply pipe 41 extends along a central axis of the rotary atomization head 32, and reaches a center of the expanding face 321.

The solvent discharger 44 includes a cylindrical cylinder 441, a piston 442 slidably provided within the cylinder 441, and a servo motor 443 which advances and retreats the piston 442 in an axial direction of the cylinder 441. The piston 442 includes a disk-shaped piston body 444 which abuts on an inner peripheral surface of the cylinder 441, and a rod-shaped piston rod 445 which is provided in the piston body 444 and is connected to the servo motor 443. The piston 442 is a feed-screw mechanism, and as the servo motor 443 is rotationally driven, the position of the piston 442 within the cylinder 441 can be adjusted with high precision.

Next, the operation when the coating material of the coating robots 11 to 16 is not diluted with the solvent and electrostatically coated will be described. First, the valve 422 is closed by a control device 50. Then, while the rotary atomization head 32 of the coating gun 30 is rotated, the gear pump 43 is driven to supply the coating material to the coating gun 30 through the coating material supply pipe 41.

Then, since the rotary atomization head 32 is rotating, a centrifugal force acts on the discharged coating material, and the coating material moves along the surface of the expanded face 321 toward its peripheral edge. As the coating material approaches the peripheral edge of the expanded face 321, the centrifugal force which acts on the coating material becomes great, and the coating material is separated into a number of fine droplets, and is turned into a mist. The misty coating material is scattered from the peripheral edge of the expanded face 321, and is applied on the surface of the body 20.

Next, the operation when the coating material of the coating robots 13 to 16 is diluted with the solvent and is electrostatically coated will be described. First, the valve 422 is closed and the valve 421 is opened, by the control device 50. In this state, the solvent is supplied to the solvent supply pipe 42 from a solvent supply source which is not shown, and the solvent is filled into the cylinder 441 of the solvent discharger 44. Next, while the rotary atomization head 32 of the coating gun 30 is rotated, the gear pump 43 is driven to supply the coating material to the coating gun 30 through the coating material supply pipe 41.

At this time, the valve 421 is closed and the valve 422 is opened, by the control device 50, and the solvent discharger 44 is driven to supply the solvent which is supplied to the solvent supply pipe 42 so that the NV value of a coated film falls within a predetermined range. Then, the coating material and the solvent are mixed inside the coating gun 30, and a centrifugal force acts on a mixture of the discharged coating material and solvent. Therefore, the mixture moves along the surface of the expanded face 321 toward its peripheral edge while being further mixed by the rotation of the rotary atomization head 32. When the mixed coating material approaches the peripheral edge of the expanded face 321, the rotary atomization head 32 rotates at high speed. Thus, the centrifugal force which acts on the mixed coating material becomes significantly large, and the mixed coating material is separated into a number of fine droplets and turned into a mist. The misty coating material is scattered from the peripheral edge of the expanded face 321, and is applied on the surface of the body 20.

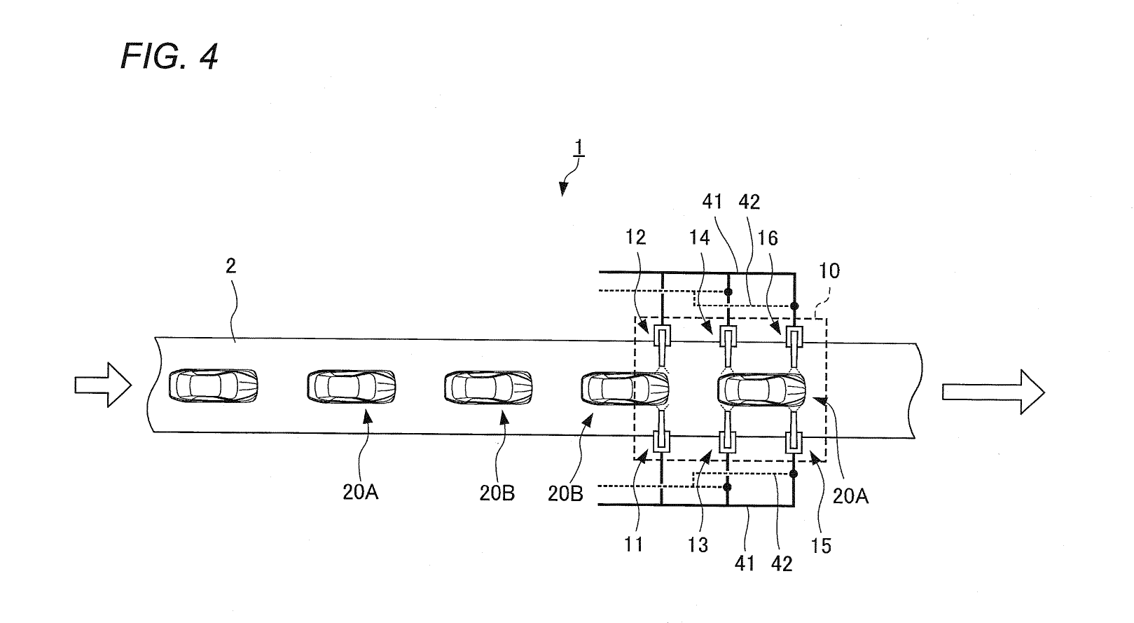

Hereinafter, the operation of the clear coating facility 10 will be described referring to FIGS. 4 to 9. In this clear coating facility 10, two kinds of bodies 20A and 20B exist in a mixed manner, and are carried from the upstream. The body 20B requires a smoothness higher than the body 20A. First, as shown in FIG. 4, the clear coating facility 10 coats the bodies 20A and 20B. Specifically, the side faces of the body 20A are coated by the coating robots 13 to 16. Additionally, the front top face of the body 20B is coated by the coating robots 11 and 12. Here, only the coating material is supplied to the coating robots 11 to 16.

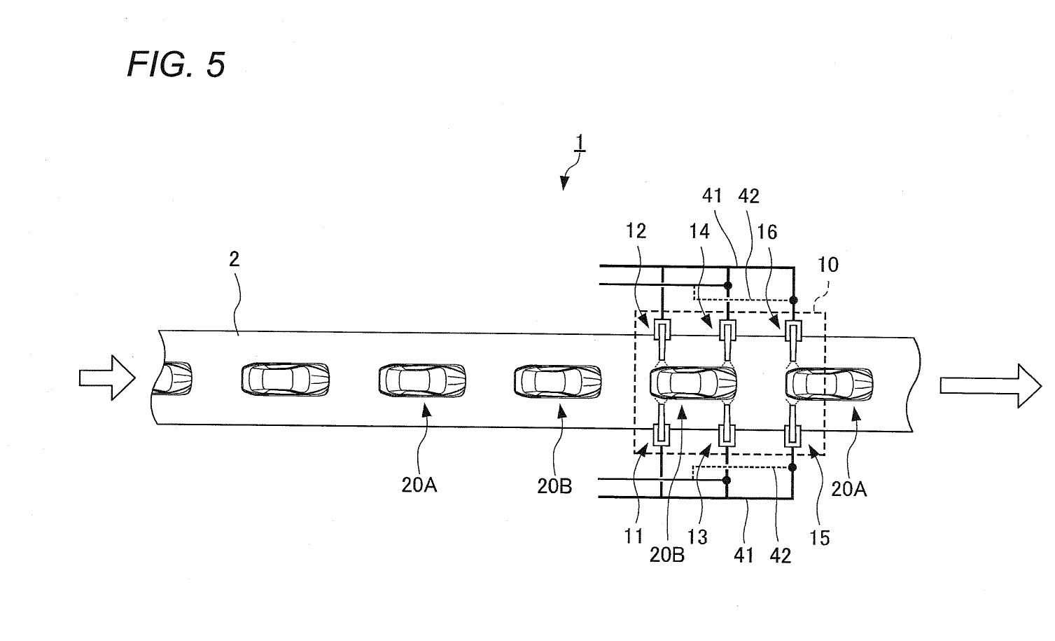

If one process moves from the state shown in FIG. 4, as shown in FIG. 5, the clear coating facility 10 coats the rear side faces of the body 20A by the coating robots 15 and 16. Further, the rear top face and front side faces of the body 20B are coated by the coating robots 11 to 14. Here, since the front side faces of the body 20B are coated by the coating robots 13 and 14, the rotary atomization head 32 of the coating gun 30 of each of the coating robots 13 and 14 is made to have a higher number of revolutions than a case where the side faces of the body 20A are coated, and simultaneously, the solvent is supplied to the coating robots 13 and 14 in addition to the coating material.

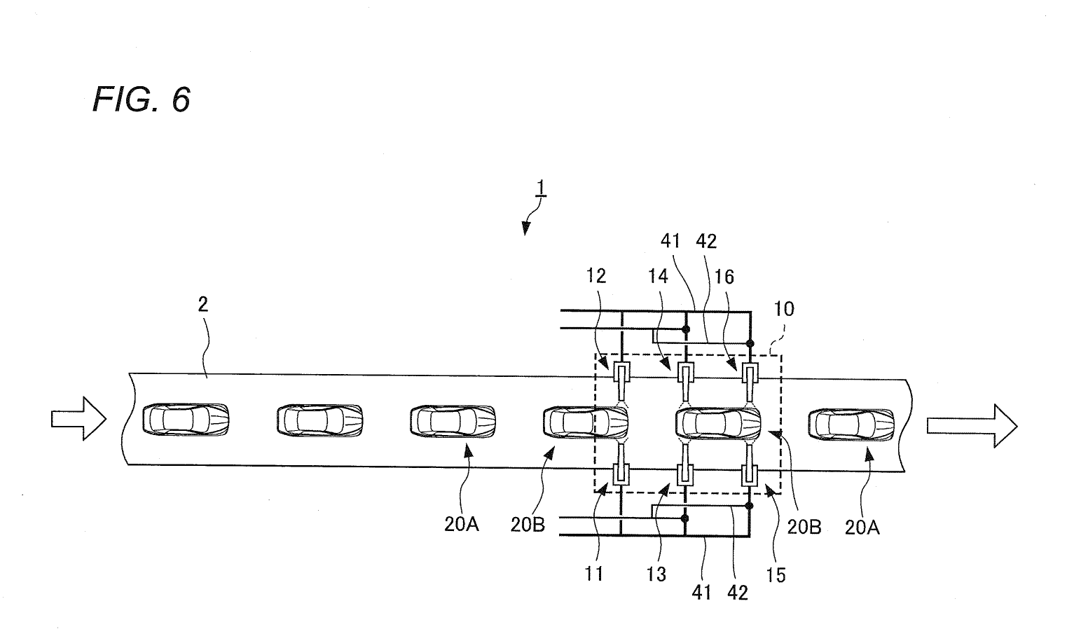

If one process moves from the state shown in FIG. 5, as shown in FIG. 6, the body 20A is carried out of the clear coating facility 10, and the body 20B is newly carried into the clear coating facility 10. Then, the side faces of the body 20B on the downstream side which has already been carried in are coated by the coating robots 13 to 16, and the front top face of the body 20B on the upstream side which has been newly carried in is coated by the coating robots 11 and 12. Here, since the side faces of the body 20B are coated by the coating robots 13 to 16, the rotary atomization head 32 of the coating gun 30 of each of the coating robots 13 to 16 is made to have a higher number of revolutions than a case where the side faces of the body 20A are coated, and simultaneously, the solvent is supplied to the coating robots 13 to 14 in addition to the coating material.

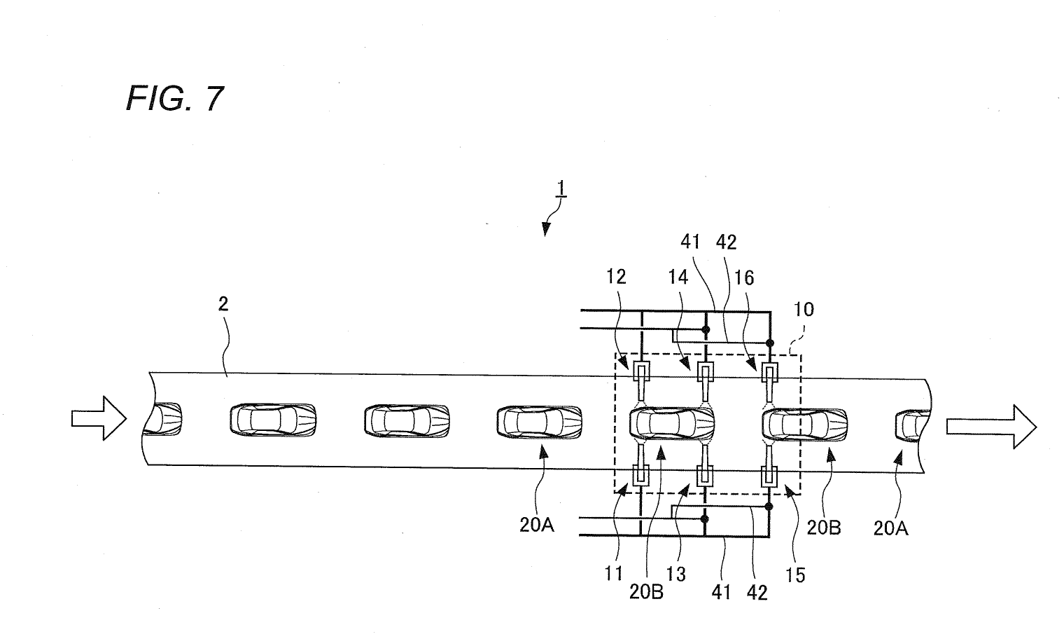

If one process moves from the state shown in FIG. 6, as shown in FIG. 7, the clear coating facility 10 coats the rear side faces of the body 20B on the downstream side by the coating robots 15 and 16. Further, the rear top face and front side faces of the body 20B on the upstream side are coated by the coating robots 11 to 14. Here, since the side faces of the body 20B are coated by the coating robots 13 to 16, the rotary atomization head 32 of the coating gun 30 of each of the coating robots 13 to 16 is made to have a higher number of revolutions than a case where the side faces of the body 20A are coated, and simultaneously, the solvent is supplied to the coating robots 13 to 16 in addition to the coating material.

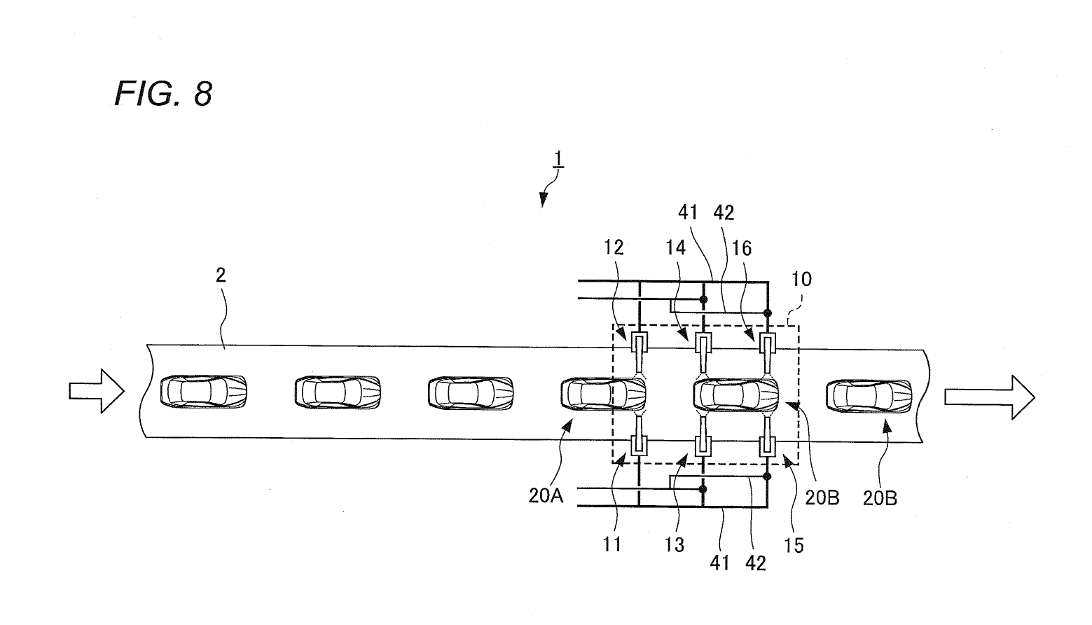

If one process moves from the state shown in FIG. 7, as shown in FIG. 8, the body 20B is carried out of the clear coating facility 10, and the body 20A is newly carried into the clear coating facility 10. Then, the side faces of the body 20B which has already been carried in are coated by the coating robots 13 to 16, and the front top face of the body 20A which has been newly carried in is coated by the coating robots 11 and 12. Here, since the coating robots 13 to 16 coat the side faces of the body 20B, the rotary atomization head 32 of the coating gun 30 of each of the coating robots 13 to 16 is made to have a higher number of revolutions than a case where the side faces of the body 20A are coated, and simultaneously, the solvent is supplied to the coating robots 13 to 16 in addition to the coating material.

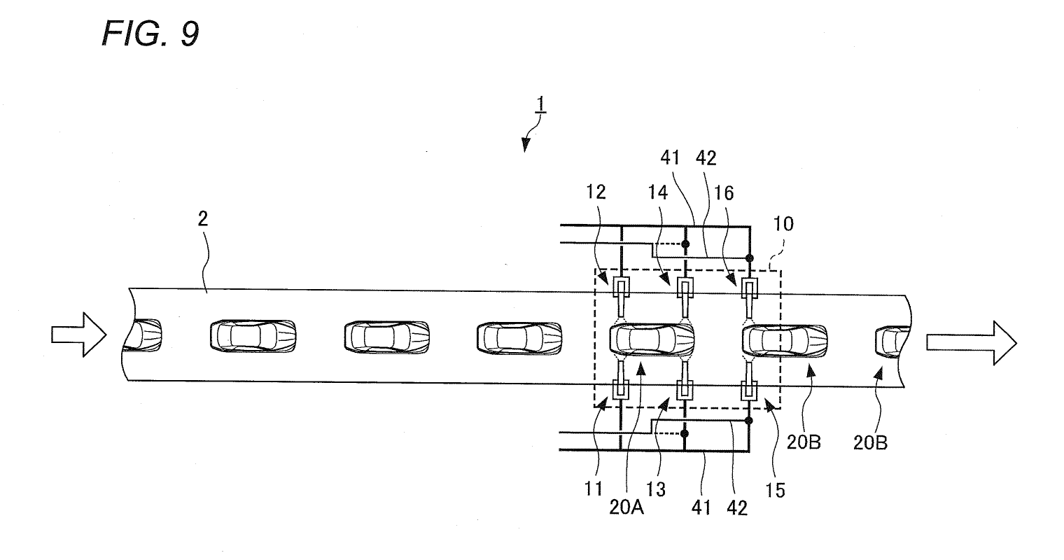

If one process moves from the state shown in FIG. 8, as shown in FIG. 9, the clear coating facility 10 coats the rear side faces of the body 20B, which has already been carried in, by the coating robots 15 and 16. Further, the rear top face and front side faces of the body 20A which has been newly carried in are coated by the coating robots 11 to 14. Here, since the coating robots 15 and 16 coat the side faces of the body 20B, the rotary atomization head 32 of the coating gun 30 of each of the coating robots 15 and 16 is made to have a higher number of revolutions than a case where the side faces of the body 20A are coated, and simultaneously, the solvent is supplied to the coating robots 15 and 16 in addition to the coating material.

### Working Example 1 and Comparative Example 1

A coating material and a solvent were supplied to the above-mentioned clear coating facility, and the ratio of the solvent to the coating material, and the relation between the NV value and the LW value were investigated.

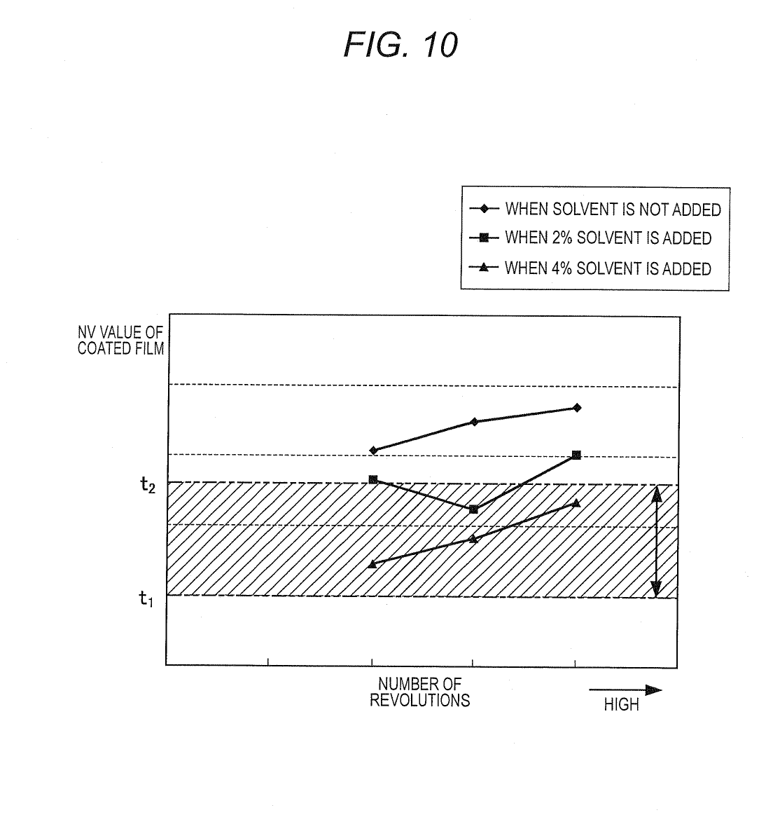

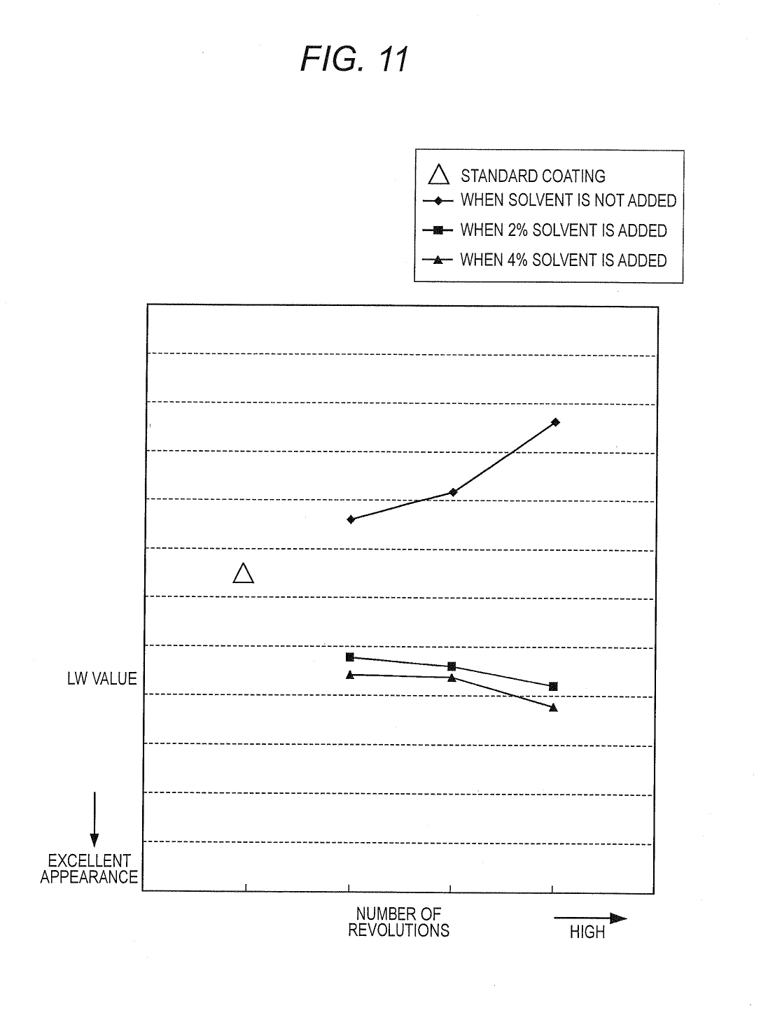

FIG. 10 is a view showing the relationship between the number of revolutions of the rotary atomization head and the NV value in the first embodiment. FIG. 11 is a view showing the relationship between the number of revolutions of the rotary atomization head and the LW value in the first embodiment. In FIG. 11, LW (Long Wave) is an index indicating the smoothness of a coated film measured by a measuring instrument called Wavescan (made by BYK Gardner GmbH). Specifically, the surface of the coated film is irradiated with a laser beam from Wavescan, the reflected light intensity of the surface of the coated film is detected, and an optical profile of the surface of the coated film is detected. Then, this optical profile is applied to a mathematical filter, the structure of the surface of the coated film is separated for every wavelength, and somewhat long measurement wavelengths are extracted and quantified. As the LW value is lower, the surface is smoother, and the appearance is better.

When a solvent is not added to a coating material, the NV value is high out of a predetermined range (a range from t₁ to t₂ in FIG. 10), and the LW value also becomes high. That is, if the number of revolutions of the rotary atomization head is elevated, particles of the coating material are atomized. Therefore, the specific surface area of the particles of the coating material increases, the amount of volatilization of the solvent in the coating material becomes great, and the NV value of a coated film also rises. As a result, the fluidity of the coated film is lowered, the leveling of the coating material deposited on a coated surface becomes inadequate, and the LW value also has a tendency to rise.

On the other hand, when the number of revolutions of the rotary atomization head is elevated, and a solvent is added to a coating material, the NV value falls within a predetermined range and the LW value becomes low. That is, if the number of revolutions of the rotary atomization head is elevated, particles of the coating material are atomized, and the specific surface area of the particles of the coating material increases. However, since a solvent is added, the degree of volatilization of the solvent in the coating material is suppressed, thereby the ratio of non-volatilization in a coated film does not become so high, and the rise of the NV value can be suppressed. Consequently, since the coating material deposited on the coated surface can be leveled without losing its fluidity, irregularities of the surface of a coated film are suppressed and LW value has a tendency to drop.

As described above, it can be understood that the LW value can be lowered to make the appearance excellent by elevating the number of revolutions of the rotary atomization head 32 to atomize particles of the coating material while managing the NV value of a coated film so as not to become higher than a predetermined range.

According to the first embodiment, there is the following advantage. The number of revolutions of the rotary atomization head 32 is elevated to atomize particles of the coating material while managing the NV value of a coated film so as not to become higher than a predetermined range. This makes it possible to minimize irregularities caused by lamination of particles of the coating material in the body 20, and secure the fluidity of the coating material deposited on the body 20. Thus, the smoothness of the body 20 can be further improved compared with a related art.

In addition, the invention is not limited to the first embodiment, and alterations, improvements, etc. within a range where the object of the invention can be achieved are included in the invention. For example, in the first embodiment, the electrostatic coating method is applied to the clear coating facility 10. However, the invention is not limited thereto. That is, the invention may be applied to a middle coating facility, and may be applied to a facility except a base coating facility in a finish coating facility like an overcoat clear coating facility (premium clear coating performed on clear coating). Additionally, the invention may be applied to one of these facilities, and may be applied to a plurality of facilities.

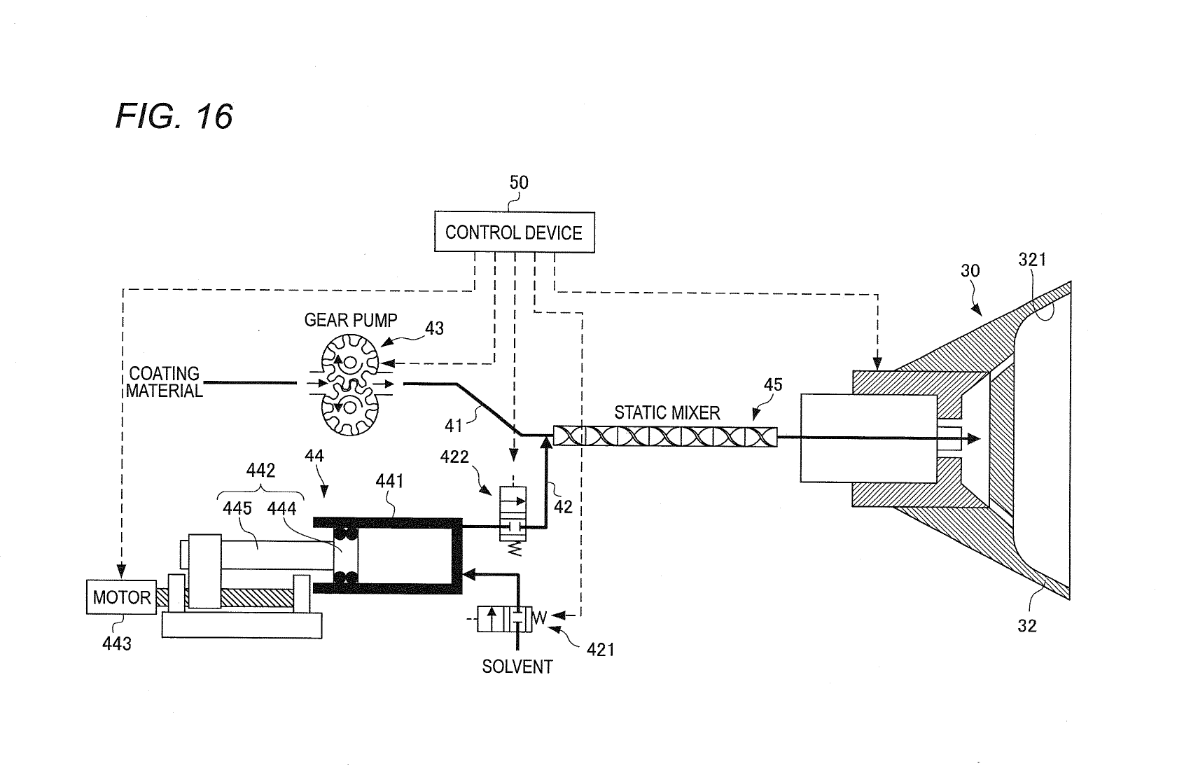

Additionally, in the first embodiment, the gun head internal mixing is adopted in the clear coating facility 10. However, the invention is not limited thereto, and the above-mentioned static mixer mixing may be adopted. That is, as shown in FIG. 16 according to a fourth embodiment of the present application which will be described later, a static mixer 45 is provided in the coating material supply pipe 41 in addition to the gear pump 43, and the solvent supply pipe 42 is connected to the static mixer 45 instead of the coating gun 30. The static mixer 45 mixes the coating material supplied from the gear pump 43 and the solvent supplied from the solvent discharger 44. Even in this way, there is the same advantage as in the first embodiment.

Next, a second embodiment of the present application will be described. Since a coating line to which an electrostatic coating method in the second embodiment is applied is the same as the coating line 1 of the first embodiment, the description thereof is omitted.

The operation in the second embodiment when the coating material of the coating robots 13 to 16 is diluted with the solvent and is electrostatically coated will be described. First, the valve 422 is closed and the valve 421 is opened, by the control device 50. In this state, the solvent is supplied to the solvent supply pipe 42 from a solvent supply source which is not shown, and the solvent is filled into the cylinder 441 of the solvent discharger 44. Next, while the rotary atomization head 32 of the coating gun 30 is rotated, the gear pump 43 is driven to supply a smaller amount of coating material than that under standard coating conditions to the coating gun 30 through the coating material supply pipe 41.

At this time, the valve 421 is closed and the valve 422 is opened, by the control device 50, and the solvent discharger 44 is driven to supply the solvent which is supplied to the solvent supply pipe 42 so that the NV value of a coated film falls within a predetermined range. Then, the coating material and the solvent are mixed inside the coating gun 30, and a centrifugal force acts on a mixture of the discharged coating material and solvent. This mixture moves along the surface of the expanded face 321 toward its peripheral edge while being further mixed by the rotation of the rotary atomization head 32. If this mixed coating material approaches the peripheral edge of the expanded face 321, the rotary atomization head 32 rotates at high speed. Thus, the centrifugal force which acts on the mixed coating material becomes significantly large, and the mixed coating material is separated into a number of fine droplets and turned into a mist. This misty coating material is scattered from the peripheral edge of the expanded face 321, and is applied on the surface of the body 20.

Hereinafter, the operation of the clear coating facility 10 in the second embodiment will be described referring to FIGS. 4 to 9. In the clear coating facility 10 of the second embodiment, two kinds of bodies 20A and 20B exist in a mixed manner, and are carried from the upstream. The body 20B requires a smoothness higher than the body 20A. First, as shown in FIG. 4, the clear coating facility 10 coats the bodies 20A and 20B. Specifically, the side faces of the body 20A are coated by the coating robots 13 to 16. Additionally, the front top face of the body 20B is coated by the coating robots 11 and 12. Here, only the coating material is supplied to the coating robots 11 to 16.

If one process moves from the state shown in FIG. 4, as shown in FIG. 5, the clear coating facility 10 coats the side faces of the rear side of the body 20A by the coating robots 15 and 16. Further, the rear top face and front side faces of the body 20B are coated by the coating robots 11 to 14. Here, since the front side faces of the body 20B are coated by the coating robots 13 and 14, the supply amount of the coating material to the rotary atomization head 32 of the coating gun 30 of each of the coating robots 13 and 14 is made smaller than that in a case where the side faces of the body 20A are coated, and simultaneously, the solvent is supplied to the coating robots 13 and 14 in addition to the coating material.

If one process moves from the state shown in FIG. 5, as shown in FIG. 6, the body 20A is carried out of the clear coating facility 10, and the body 20B is newly carried into the clear coating facility 10. Then, the side faces of the body 20B on the downstream side which has already been carried in are coated by the coating robots 13 to 16, and the front top face of the body 20B on the upstream side which has been newly carried in is coated by the coating robots 11 and 12. Here, since the side faces of the body 20B on the downstream side are coated by the coating robots 13 to 16, the supply amount of the coating material to the rotary atomization head 32 of the coating gun 30 of each of the coating robots 13 to 16 is made smaller than that in a case where the side faces of the body 20A are coated, and simultaneously, the solvent is supplied to the coating robots 13 to 16 in addition to the coating material.

If one process moves from the state shown in FIG. 6, as shown in FIG. 7, the clear coating facility 10 coats the rear side faces of the body 20B on the downstream side by the coating robots 15 and 16. Further, the rear top face and front side faces of the body 20B on the upstream side are coated by the coating robots 11 to 14. Here, since the side faces of the body 20B are coated by the coating robots 13 to 16, the supply amount of the coating material to the rotary atomization head 32 of the coating gun 30 of each of the coating robots 13 to 16 is made smaller than that in a case where the side faces of the body 20A are coated, and simultaneously, the solvent is supplied to the coating robots 13 to 16 in addition to the coating material.

If one process moves from the state shown in FIG. 7, as shown in FIG. 8, the body 20B is carried out of the clear coating facility 10, and the body 20A is newly carried into the clear coating facility 10. Then, the side faces of the body 20B which has already been carried in are coated by the coating robots 13 to 16, and the front top face of the body 20A which has been newly carried in is coated by the coating robots 11 and 12. Here, since the coating robots 13 to 16 coat the side faces of the body 20B, the supply amount of the coating material to the rotary atomization head 32 of the coating gun 30 of each of the coating robots 13 to 16 is made smaller than that in a case where the side faces of the body 20A are coated, and simultaneously, the solvent is supplied to the coating robots 13 to 16 in addition to the coating material.

If one process moves from the state shown in FIG. 8, as shown in FIG. 9, the clear coating facility 10 coats the rear side faces of the body 20B, which has already been carried in, by the coating robots 15 and 16. Further, the rear top face and front side faces of the body 20A which has been newly carried in are coated by the coating robots 11 to 14. Here, since the coating robots 15 and 16 coat the side faces of the body 20B, the supply amount of the coating material to the rotary atomization head 32 of the coating gun 30 of each of the coating robots 15 and 16 is made smaller than that in a case where the side faces of the body 20A are coated, and simultaneously, the solvent is supplied to the coating robots 15 and 16 in addition to the coating material.

### Working Example 2 and Comparative Example 2

A coating material and a solvent were supplied to the clear coating facility of the second embodiment, and the relationship between the ratio of the solvent to the coating material and the NV value or the LW value were investigated.

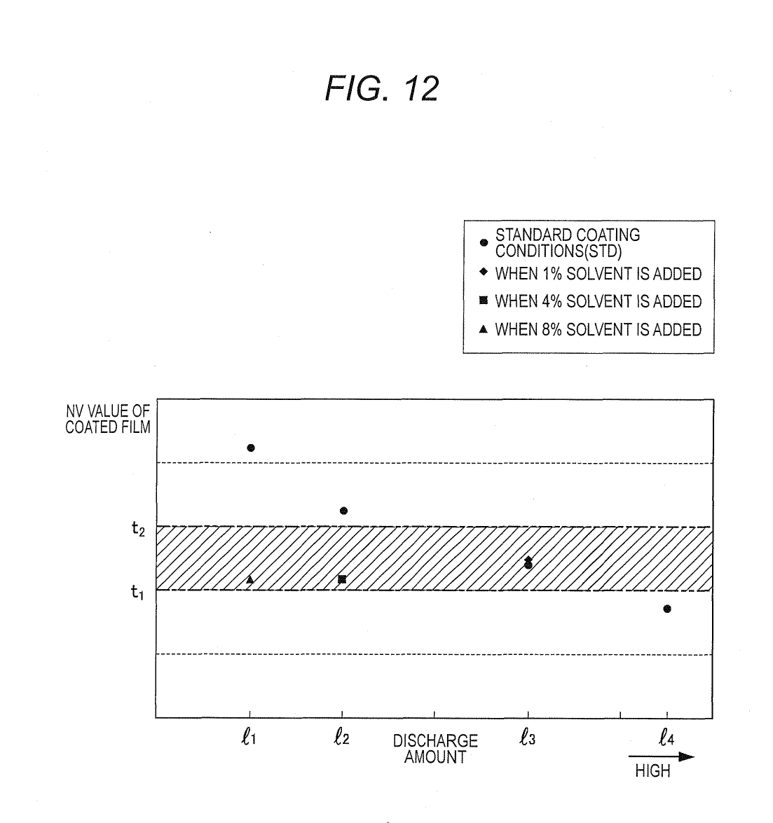

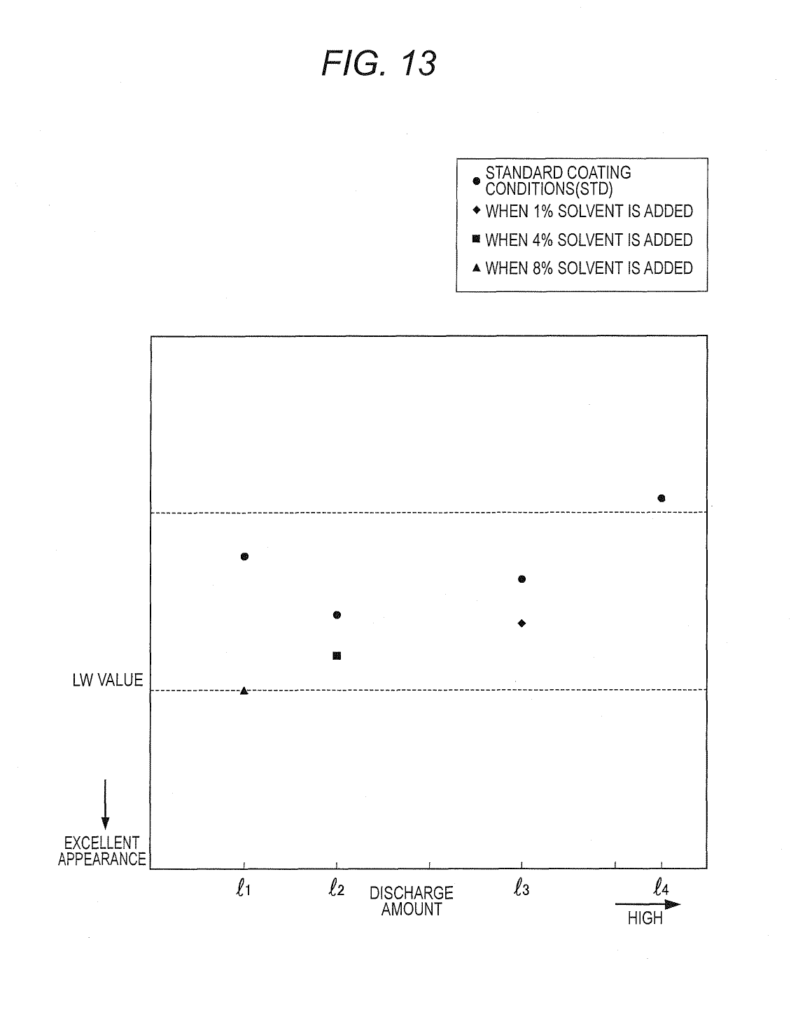

FIG. 12 is a drawing showing the relationship between the discharge amount of the rotary atomization head and the NV value when the number of revolutions of the rotary atomization head is constant in the second embodiment. FIG. 13 is a drawing showing the relationship between the discharge amount of the rotary atomization head and the LW value when the number of revolutions of the rotary atomization head is constant in the second embodiment.

In a case of normal coating (standard conditions) where the supply amount of the coating material to the rotary atomization head is not reduced, as the discharge amount is reduced from 1₄ to 1₁ the NV value becomes high. Here, when the discharge amount is 1₃, the NV value falls within a predetermined range (a range from t₁ to t₂ in FIG. 12). In this case, however, the LW value is only slightly lowered as shown FIG. 13. That is, if the supply amount of the coating material to the rotary atomization head is reduced, particles of the coating material are atomized. Therefore, the specific surface area of the particles of the coating material increases, whereby the NV value of a coated film becomes high. Consequently, the effect of atomization of particles of the coating material is reduced by half, and the LW value is not greatly lowered.

On the other hand, when a solvent is added to a coating material so that the NV value falls within a predetermined range in addition to the reduction of the supply amount of the coating material to the rotary atomization head, the LW value becomes markedly low. That is, if the supply amount of the coating material to the rotary atomization head is reduced, particles of the coating material are atomized, and the specific surface area of the particles of the coating material increases. However, since a solvent is added, the amount of volatilization of the solvent in the coating material is suppressed, the ratio of non-volatilization in a coated film does not become so high, and the rise of the NV value can be suppressed. Consequently, since the fluidity of the coating material deposited on a coated surface is secured and the leveling of the coated film is promoted, the irregularities of the surface of the coated film are suppressed, and the LW value becomes markedly low.

As described above, it can be understood that the LW value can be lowered to make the appearance excellent by reducing the discharge amount of the coating material from the rotary atomization head 32 to atomize particles of the coating material while managing the NV value of a coated film so as not to become higher than a predetermined range in a state where the number of revolutions of the rotary atomization head 32 is constant.

According to the second embodiment, there is the following advantage. The discharge amount of the coating material from the rotary atomization head 32 is reduced to atomize particles of the coating material while managing the NV value of a coated film so as not to become higher than a predetermined range in a state where the number of revolutions of the rotary atomization head 32 is constant. This makes it possible to minimize irregularities caused by lamination of particles of the coating material in the body 20, and secure the fluidity of the coating material deposited on the body 20. Thus, the smoothness of the body 20 can be further improved compared with the related art.

Next, a third embodiment of the present application will be described. Since a coating line to which an electrostatic coating method in the third embodiment is applied is the same as the coating line 1 of the first embodiment, the description thereof is omitted.

The operation in the third embodiment when the coating material of the coating robots 13 to 16 is diluted with the solvent and is electrostatically coated will be described. First, the valve 422 is closed and the valve 421 is opened, by the control device 50. In this state, the solvent is supplied to the solvent supply pipe 42 from a solvent supply source which is not shown, and the solvent is filled into the cylinder 441 of the solvent discharger 44. Next, while the rotary atomization head 32 of the coating gun 30 is rotated, the gear pump 43 is driven to supply a smaller amount of coating material than that under standard coating conditions to the coating gun 30 through the coating material supply pipe 41.

At this time, the valve 421 is closed and the valve 422 is opened, by the control device 50, and the solvent discharger 44 is driven to supply the solvent which is supplied to the solvent supply pipe 42 so that the NV value of a coated film falls within a predetermined range. Then, the coating material and the solvent are mixed inside the coating gun 30, and a centrifugal force acts on a mixture of the discharged coating material and solvent. This mixture moves along the surface of the expanded face 321 toward its peripheral edge while being further mixed by the rotation of the rotary atomization head 32. If this mixed coating material approaches the peripheral edge of the expanded face 321, the rotary atomization head 32 rotates at high speed. Thus, the centrifugal force which acts on the mixed coating material becomes significantly great, and the mixed coating material is separated into a number of fine droplets and turned into a mist. This misty coating material is scattered from the peripheral edge of the expanded face 321, and is applied on the surface of the body 20.

Hereinafter, the operation of the clear coating facility 10 in the third embodiment will be described referring to FIGS. 4 to 9. In the clear coating facility 10 of the third embodiment, two kinds of bodies 20A and 20B exist in a mixed manner, and are carried from the upstream. The body 20B requires smoothness higher than the body 20A. First, as shown in FIG. 4, the clear coating facility 10 coats the bodies 20A and 20B. Specifically, the side faces of the body 20A are coated by the coating robots 13 to 16. Additionally, the front top face of the body 20B is coated by the coating robots 11 and 12. Here, only the coating material is supplied to the coating robots 11 to 16.

If one process moves from the state shown in FIG. 4, as shown in FIG. 5, the clear coating facility 10 coats the side faces of the rear side of the body 20A by the coating robots 15 and 16. Further, the rear top face and front side faces of the body 20B are coated by the coating robots 11 to 14. Here, since the front side faces of the body 20B are coated by the coating robots 13 and 14, the rotary atomization head 32 of the coating gun 30 of each of the coating robots 13 and 14 is made to have a higher number of revolutions than a case where the side faces of the body 20A are coated, the supply amount of the coating material is made smaller than that under standard coating conditions, and simultaneously, the solvent is supplied to the coating robots 13 and 14 in addition to the coating material.

If one process moves from the state shown in FIG. 5, as shown in FIG. 6, the body 20A is carried out of the clear coating facility 10, and the body 20B is newly carried into the clear coating facility 10. Then, the side faces of the body 20B on the downstream side which has already been carried in are coated by the coating robots 13 to 16, and the front top face of the body 20B on the upstream side which has been newly carried in is coated by the coating robots 11 and 12. Here, since the side faces of the body 20B on the down stream side are coated by the coating robots 13 to 16, the rotary atomization head 32 of the coating gun 30 of each of the coating robots 13 to 16 is made to have a higher number of revolutions than a case where the side faces of the body 20A are coated, the supply amount of the coating material is made smaller than that under standard coating conditions, and simultaneously, the solvent is supplied to the coating robots 13 to 16 in addition to the coating material.

If one process moves from the state shown in FIG. 6, as shown in FIG. 7, the clear coating facility 10 coats the rear side faces of the body 20B on the downstream side by the coating robots 15 and 16. Further, the rear top face and front side faces of the body 20B on the upstream side are coated by the coating robots 11 to 14. Here, since the side faces of the body 20B are coated by the coating robots 13 to 16, the rotary atomization head 32 of the coating gun 30 of each of the coating robots 13 to 16 is made to have a higher number of revolutions than a case where the side faces of the body 20A are coated, the supply amount of the coating material is made smaller than that under standard coating conditions, and simultaneously, the solvent is supplied to the coating robots 13 to 16 in addition to the coating material.

If one process moves from the state shown in FIG. 7, as shown in FIG. 8, the body 20B is carried out of the clear coating facility 10, and the body 20A is newly carried into the clear coating facility 10. Then, the side faces of the body 20B which has already been carried in are coated by the coating robots 13 to 16, and the front top face of the body 20A which has been newly carried in is coated by the coating robots 11 and 12. Here, since the coating robots 13 to 16 coat the side faces of the body 20B, the rotary atomization head 32 of the coating gun 30 of each of the coating robots 13 to 16 is made to have a higher number of revolutions than a case where the side faces of the body 20A are coated, the supply amount of the coating material is made smaller than that under standard coating conditions, and simultaneously, the solvent is supplied to the coating robots 13 to 16 in addition to the coating material.

If one process moves from the state shown in FIG. 8, as shown in FIG. 9, the clear coating facility 10 coats the rear side faces of the body 20B, which has already been carried in, by the coating robots 15 and 16. Further, the rear top face and front side faces of the body 20A which has been newly carried in are coated by the coating robots 11 to 14. Here, since the coating robots 15 and 16 coat the side faces of the body 20B, the rotary atomization head 32 of the coating gun 30 of each of the coating robots 15 and 16 is made to have a higher number of revolutions than a case where the side faces of the body 20A are coated, the supply amount of the coating material is made smaller than that under standard coating conditions, and simultaneously, the solvent is supplied to the coating robots 15 and 16 in addition to the coating material.

### Working Example 3 and Comparative Example 3

A coating material and a solvent were supplied to the clear coating facility of the third embodiment, and the relationship between the ratio of the solvent to the coating material and the NV value or the LW value were investigated.

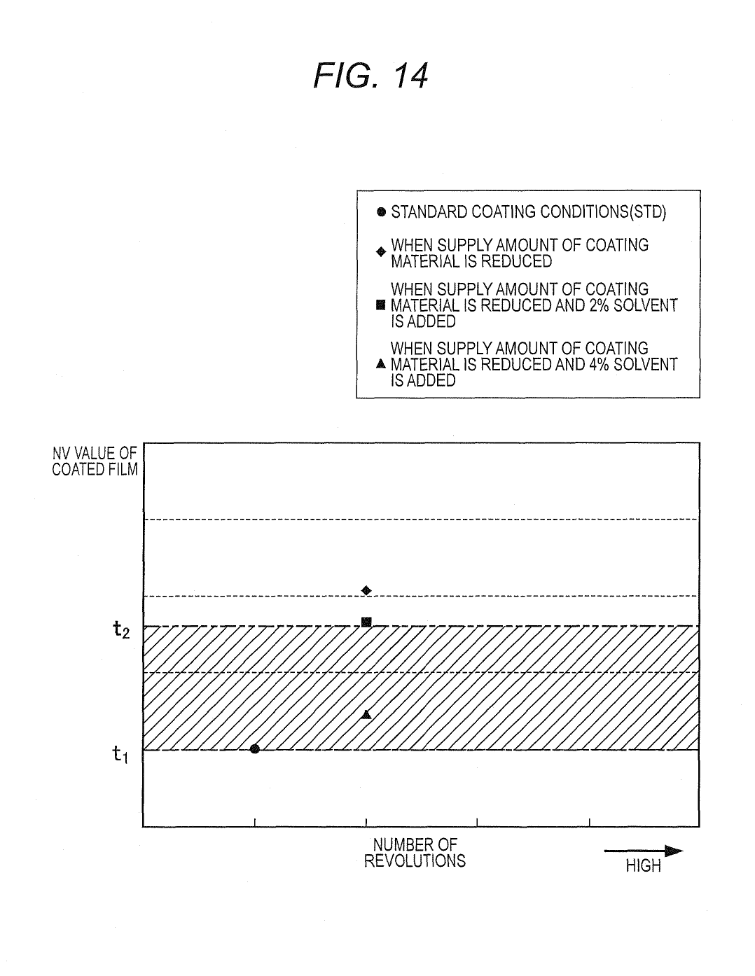

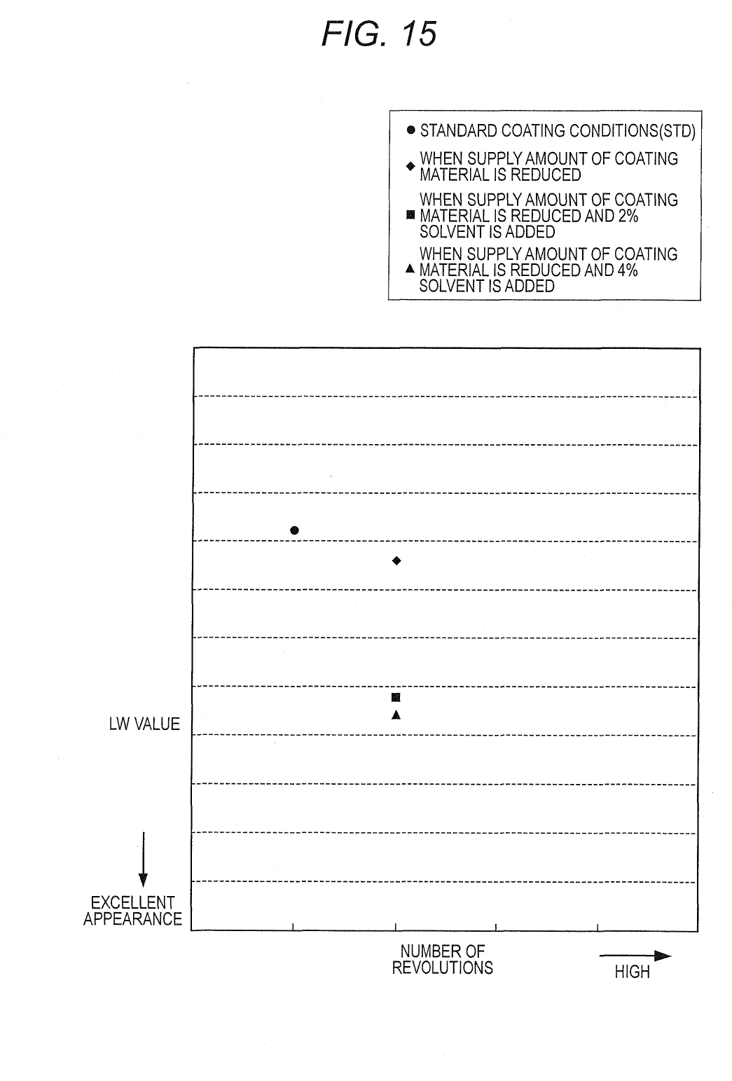

FIG. 14 is a view showing the relationship between the number of revolutions of the rotary atomization head and the NV value in the third embodiment. FIG. 15 is a view showing the relationship between the number of rotations of the rotary atomization head and the LW value in the third embodiment.

In a case of normal coating (standard conditions) where the supply amount of the coating material to the rotary atomization head is not reduced, and the number of revolutions is not elevated, the NV value falls within a predetermined range (a range from t₁ to t₂ in FIG. 14), but the LW value is kept high as shown in FIG. 15.

On the other hand, when the supply amount of the coating material to the rotary atomization head is reduced, and the number of revolutions is elevated, the NV value becomes higher than a predetermined range (a range from t₁ to t₂ in FIG. 14). As a result, even if the fluidity of a coated film is lost, and particles of the coating material are atomized, the LW value is only slightly lowered. That is, if the supply amount of the coating material to the rotary atomization head is reduced, and the number of revolutions of the rotary atomization head is elevated, particles of the coating material are atomized. Therefore, the specific surface area of the particles of the coating material increases, whereby the NV value of a coated film becomes high. Consequently, the effect of atomization of particles of the coating material is reduced by half, and the LW value is not greatly lowered.

In addition, when a solvent is added to a coating material in addition to the reduction of the supply amount of the coating material to the rotary atomization head, and the elevation of the number of revolutions of the rotary atomization head, the NV value falls within a predetermined range, and the LW value becomes markedly low. That is, if the supply amount of the coating material to the rotary atomization head is reduced and the number of revolutions of the rotary atomization head is elevated, particles of the coating material are atomized, and the specific surface area of the particles of the coating material increases. However, since a solvent is added, the amount of volatilization of the solvent in the coating material is suppressed, the ratio of non-volatilization in a coated film does not become so high, and the rise of the NV value can be suppressed. Consequently, since the fluidity of the coating material deposited on a coated surface is secured and the leveling of the coated film is promoted, the irregularities of the surface of the coated film are suppressed, and the LW value becomes markedly low.

As described above, it can be understood that the LW value can be lowered to make the appearance excellent by elevating the number of revolutions of the rotary atomization head 32 and reducing the discharge amount of the coating material from the rotary atomization head 32 to atomize particles of the coating material while managing the NV value of a coated film so as not to become higher than a predetermined range.

According to the third embodiment, there is the following advantage. The number of revolutions of the rotary atomization head 32 is elevated and the discharge amount of the coating material from the rotary atomization head 32 is reduced to atomize particles of the coating material while managing the NV value of a coated film so as not to become higher than a predetermined range. This makes it possible to minimize irregularities caused by lamination of particles of the coating material in the body 20, and secure the fluidity of the coating material deposited on the body 20. Thus, the smoothness of the body 20 can be further improved compared with the related art.

Next, a fourth embodiment of the present application will be described. FIG. 16 is a schematic diagram showing the detailed structure of the coating robots 13 to 16 of the clear coating facility 10 of the fourth embodiment. The clear coating facility 10 includes a gear pump 43 serving as a coating material supply unit which supplies a coating material, a solvent discharger 44 serving as a solvent supply unit which supplies a solvent, a static mixer 45 serving as a mixing unit which mixes the coating material supplied from the gear pump 43 and the solvent supplied from the solvent discharger 44, and a control device 50 serving as a control unit which controls these unit.

The above-described coating material supply pipe 41 is connected to the coating gun 30 of each of the coating robots 13 to 16, and the gear pump 43 and the static mixer 45 are provided in the middle of the coating material supply pipe 41. The above-described solvent supply pipe 42 is connected to the static mixer 45, and the solvent discharger 44 is provided in the middle of the solvent supply pipe 42. Additionally, valves 421 and 422 are provided on the upstream and downstream sides of the solvent discharger 44 of the solvent supply pipe 42. The above-described coating gun 30 sprays the mixed coating material and solvent by the static mixer 45.

The coating gun 30 includes a main body which is not shown, and a rotary atomization head 32 rotatably provided in the main body.

The main body is cylindrical, and includes an air motor (not shown which rotates the rotary atomization head 32 with the air pumped from a compressor, and a high-voltage generator (not shown) which charges the coating material, other than the coating material supply pipe 41 which supplies the coating material to the rotary atomization head 32, and the solvent supply pipe 42 which supplies the solvent to the coating material supply pipe 41. The rotary atomization head 32 is formed with an expanding face 321 which expands toward a jetting direction. The coating material supply pipe 41 extends along the central axis of the rotary atomization head 32, and reaches the center of the expanding face 321.

The solvent discharger 44 includes a cylindrical cylinder 441, a piston 442 slidably provided within the cylinder 441, and a servo motor 443 which advances and retreats the piston 442 in the axial direction of the cylinder 441. The piston 442 includes a disk-shaped piston body 444 which abuts on the inner peripheral surface of the cylinder 441, and a rod-shaped shaft 445 which is provided in the piston body 444 and is connected to the servo motor 443. The piston 442 is a feed-screw mechanism, and as the servo motor 443 is rotationally driven, the position of the piston 442 within the cylinder 441 can be adjusted with high precision.

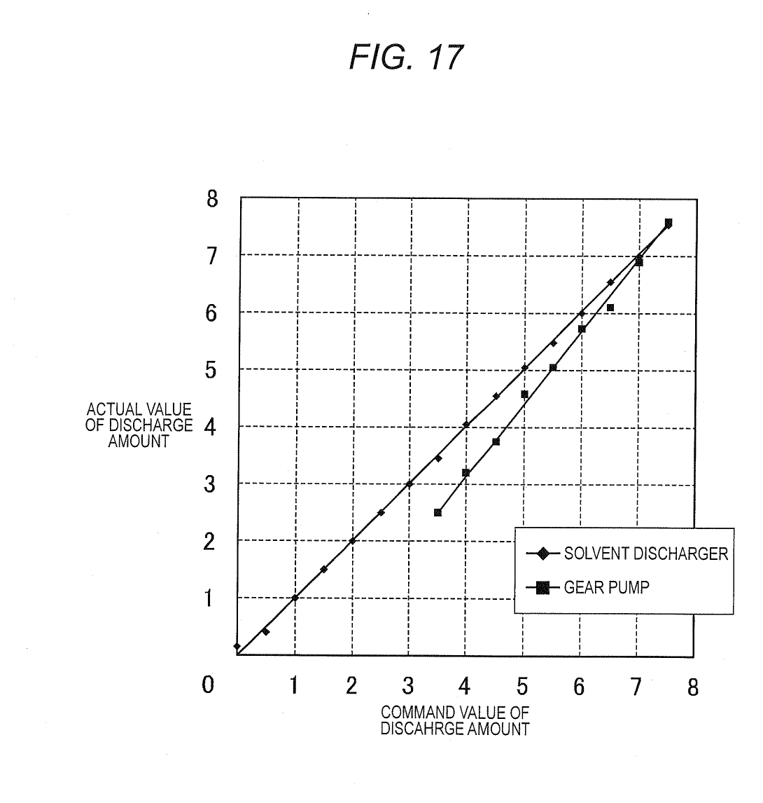

FIG. 17 is a drawing showing the relationship between the command value of the discharge amount, and an actual measurement value about a gear pump and solvent discharger. It can be understood from FIG. 17 that the actual discharge amount of the solvent discharger substantially exactly corresponds to a command value. On the other hand, it can be understood that the actual discharge amount of the gear pump is smaller than a command value, and if the command value becomes small to some extent, discharge cannot be made.

The control device 50 controls the gear pump 43, the solvent discharger 44, and the coating gun 30 to spray the coating material from the coating gun 30.

Next, the operation of the coating robots 13 to 16 when the coating material is diluted with the solvent and is electrostatically coated will be described. First, the valve 422 is closed and the valve 421 is opened, by the control device 50. In this state, the solvent is supplied to the solvent supply pipe 42 from a solvent supply source which is not shown, and the solvent is filled into the cylinder 441 of the solvent discharger 44. Next, the gear pump 43 is driven to supply the coating material to the static mixer 45 through the coating material supply pipe 41.

Then, in a case where the NV value of a coated film is out of a predetermined range due to a high number of revolutions (higher than standard coating conditions), a small amount of coating material supplied (less than the standard coating conditions), etc. of the rotary atomization head, simultaneously when the coating material is supplied to the coating material supply pipe 41, the valve 421 is closed and the valve 422 is opened to drive the solvent discharger 44, and the solvent is supplied to the solvent supply pipe 42 and the coating material and the solvent are mixed by the static mixer 45 so that the NV value of the coated film falls within a predetermined range.

Then, since the rotary atomization head 32 is rotating, a centrifugal force acts on a mixture of the discharged coating material and solvent, and the mixture moves along the surface of the expanded face 321 toward its peripheral edge while being further mixed by the rotation of the rotary atomization head 32. If this mixed coating material approaches the peripheral edge of the expanded face 321, the rotary atomization head 32 rotates at high speed. Thus, the centrifugal force which acts on the coating material becomes significantly large, and the coating material is separated into a number of fine droplets and turned into a mist. This misty coating material is scattered from the peripheral edge of the expanded face 321, and is applied on the surface of the body 20.

Since the operation of the clear coating facility 10 in the fourth embodiment is the same as that of the first embodiment, the description thereof is omitted.

Further, since the relationship between the ratio of the solvent to the coating material and the NV value or the LW value in the fourth embodiment is the same as that of the first embodiment, the description thereof is also omitted.

According to the fourth embodiment, there are the following advantages. (1) The solvent discharger 44 was driven to adjust the supply amount of the solvent so that the NV value of a coated film formed on a coated surface might fall within a predetermined range. By making the NV value of the coated film fall within a predetermined range, the properties of a mixed coating material can be managed. Thus, the fluidity of the coating material deposited on the coated surface can be secured, and high smoothness for the appearance of the coated surface can be obtained.

(2) The solvent was supplied by using the cylinder type solvent discharger 44 in which the piston 442 driven by the servo motor 443 is provided. Since the solvent discharger has the structure which can control a small amount of discharge with high precision, the properties of a coating material can be reliably managed.

(3) Since the coating material and the solvent were mixed in the vicinity of the coating gun 30 by the combination of the static mixer 45 and the rotary atomization head 32, a coating material with a desired NV value can be supplied without time lag compared with a case where the coating material and the solvent are mixed within a coating material circulation tank.

In addition, the invention is not limited to the fourth embodiment, and alterations, improvements, etc. within a range where the object of the invention can be achieved are included in the invention. For example, in the fourth embodiment, the electrostatic coating apparatus and the electrostatic coating method are applied to the clear coating facility 10. However, the invention is not limited thereto. That is, the invention may be applied to a middle coating facility, and may be applied to a facility except a base coating facility in a finish coating facility like an overcoat clear coating facility (premium clear coating performed on clear coating). Additionally, the invention may be applied to one of these facilities, and may be applied to a plurality of facilities.

Additionally, in the fourth embodiment, a solvent and a coating material are mixed by the static mixer 45 before being supplied to the rotary atomization head 32. However, when the kind of a coating material is changed in the course of coating, the mixed coating material from the static mixer 45 to the coating gun 30 should be discarded. Thus, for example, as the first to third embodiment shown in FIG. 3, the static mixer may not be provided in the coating material supply pipe 41, and the solvent supply pipe 42 may be connected not to the static mixer but to the coating gun 30. Even in such gun head internal mixing by the rotary atomization head, there are the same advantages as the above-described (1) and (2).

While the present inventive concept has been shown and described with reference to certain exemplary embodiments thereof, it will be understood by those skilled in the art that various changes in form and details may be made therein without departing from the spirit and scope of the invention as defined by the appended claims.

1. An electrostatic coating method comprising:
providing a rotary atomization type coating apparatus;
supplying a coating material to a rotary atomization head of the rotary atomization type coating apparatus;
changing the number of revolutions of the rotary atomization head to change a particle diameter of particles of the coating material;
adding a solvent to the coating material so that a NV value of a coated film formed on a coated surface of a workpiece falls within a predetermined range; and
electrostatically coating the coated surface with the coating material and the solvent.

2. The electrostatic coating method according to claim 1, wherein a supply amount of the coating material to the rotary atomization head is changed so as to change the particle diameter of the particles of the coating material.

3. An electrostatic coating method comprising:
providing a rotary atomization type coating apparatus;
rotating a rotary atomization head of the rotary atomization type coating apparatus;
changing a supply amount of a coating material to the rotary atomization head to change a particle diameter of particles of the coating material;
adding a solvent to the coating material so that a NV value of a coated film formed on a coated surface of a workpiece falls within a predetermined range, and
electrostatically coating the coated surface with the coating material and the solvent.

4. The electrostatic coating method according to claim 3, wherein the number of revolutions of the rotary atomization head is changed so as to change the particle diameter of the particles of the coating material.

5. An electrostatic coating method comprising:
providing a coating material supply unit which supplies a coating material, a solvent supply unit which supplies a solvent, a mixing unit which mixes the coating material supplied from the coating material supply unit and the solvent supplied from the solvent supply unit, and a rotary atomization type coating apparatus which sprays the coating material and solvent mixed by the mixing unit;
driving the solvent supply unit to adjust a supply amount of solvent so that a NV value of a coated film formed on a coated surface of a workpiece falls within a predetermined range; and
electrostatically coating the coated surface with the coating material and the solvent.

6. The electrostatic coating method according to claim 5,
wherein the solvent supply unit includes a cylinder type solvent discharger having a piston driven by a servo motor.

7. An electrostatic coating apparatus comprising:
a coating material supply unit which supplies a coating material;
a solvent supply unit which supplies a solvent;
a mixing unit which mixes the coating material supplied from the coating material supply unit and the solvent supplied from the solvent supply unit;
a rotary atomization type coating apparatus which sprays the coating material and the solvent mixed by the mixing unit to a coated surface of a workpiece; and
a control unit which controls the coating material supply unit, the solvent supply unit, the mixing unit and the rotary atomization type coating apparatus;
wherein the control unit drives the solvent supply unit to adjust a supply amount of the solvent so that a NV value of a coated film formed on the coated surface falls within a predetermined range.

8. The electrostatic coating apparatus according to claim 7,
wherein the solvent supply unit includes a cylinder type solvent discharger having a piston driven by a servo motor.
